(19) United States
(12) Patent Application Publication
(10) Pub. No.: US 2024/0324610 A1
(43) Pub. Date: Oct. 3, 2024

(54) COLLAGEN PROTEIN BARS METHOD AND DEVICES

(71) Applicant: Gina Roach, Santa Clarita, CA (US)

(72) Inventor: Gina Roach, Santa Clarita, CA (US)

(21) Appl. No.: 18/128,679

(22) Filed: Mar. 30, 2023

(51) Int. Cl. A21D 13/066; A21D 2/16; A21D 2/18; A21D 2/26; A21D 2/34; A21D 2/36; A21D 13/043

(52) U.S. Cl. CPC A21D 13/066; A21D 2/165; A21D 2/181; A21D 2/261; A21D 2/34; A21D 2/364; A21D 13/043

(57) ABSTRACT

The embodiments disclose a process for manufacturing a collagen protein bar including mixing an organic coconut oil with organic coconut sugar sweetener and jumbo eggs in predetermined quantities, blending baking soda, pink Himalayan sea salt and pure vanilla extract ingredients in predetermined quantities into the mixed oil, sweeteners and eggs mixture, combining with ingredients organic cassava flour and collagen protein ingredients in predetermined quantities, wherein the collagen protein source is in a range from 15% to 20% by weight of the collagen protein bar and the organic cassava flour in a range from 28% to 34% by weight of the collagen protein bar, mixing at least one organic nut and at least one chocolate in predetermined quantities into the cassava flour and collagen protein ingredient combination, baking the mixture in an oven at a predetermined temperature for a predetermined time and forming the baked mixture into a collagen protein bar.

### BACKGROUND

A healthy diet not only includes foods and ingredients that provide a person with health benefits but should also avoid foods and ingredients that can negatively affect a person's health. A large number of people have been impacted by the negative effects of gluten. Gluten-free offerings have been available at many restaurants. Another ingredient with negative impacts yet unknown to most people is lectin. Lectins are in several plants that are used in dietary foods. What is needed is a greater number of foods that do not include lectin to provide consumers with the means of avoiding the short and long-term negative impacts of lectin.

### BRIEF DESCRIPTION OF THE DRAWINGS

FIG. 1 shows for illustrative purposes only an example of a collagen protein bar ingredients of one embodiment.

FIG. 2A shows a block diagram of an overview flow chart of preparing collagen protein bar ingredients of one embodiment.

FIG. 2B shows a block diagram of an overview flow chart of manufacturing processes for baking in an oven collagen protein bars of one embodiment.

FIG. 3A shows a block diagram of an overview flow chart of the manufacturing process for a plurality of holding tanks of one embodiment.

FIG. 3B shows a block diagram of an overview flow chart of a continuation of the manufacturing process for baking the pressed mixture of one embodiment.

FIG. 4 shows for illustrative purposes only an example of a manufacturing mixing process of collagen protein bars of one embodiment.

FIG. 5 shows for illustrative purposes only an example of a manufacturing baking process of collagen protein bars of one embodiment.

FIG. 6 shows for illustrative purposes only an example of the refrigeration and cutting process of collagen protein bars of one embodiment.

FIG. 7 shows for illustrative purposes only an example of a manufacturing packaging process of collagen protein bars of one embodiment.

FIG. 8 shows a block diagram of an overview of collagen protein bar ingredients by weight of one embodiment.

FIG. 9 shows a block diagram of an overview of a collagen protein bar taste components of one embodiment.

FIG. 10 shows a block diagram of an overview of collagen protein bar chewiness of one embodiment.

FIG. 11 shows a block diagram of an overview of a process for manufacturing a collagen protein bar of one embodiment.

### DETAILED DESCRIPTION OF THE INVENTION

In a following description, reference is made to the accompanying drawings, which form a part hereof, and in which are shown by way of illustration a specific example in which the invention may be practiced. It is to be understood that other embodiments may be utilized and structural changes may be made without departing from the scope of the present invention.

### General Overview

It should be noted that the descriptions that follow, for example, in terms of collagen protein bars method and devices described for illustrative purposes and the underlying system can apply to any number and multiple types of protein bar ingredients. In one embodiment of the present invention, the collagen protein bars can be configured using rolled oats. The collagen protein bars can be configured to include gluten-free ingredients and can also be configured to include lectin-free ingredients using the present invention.

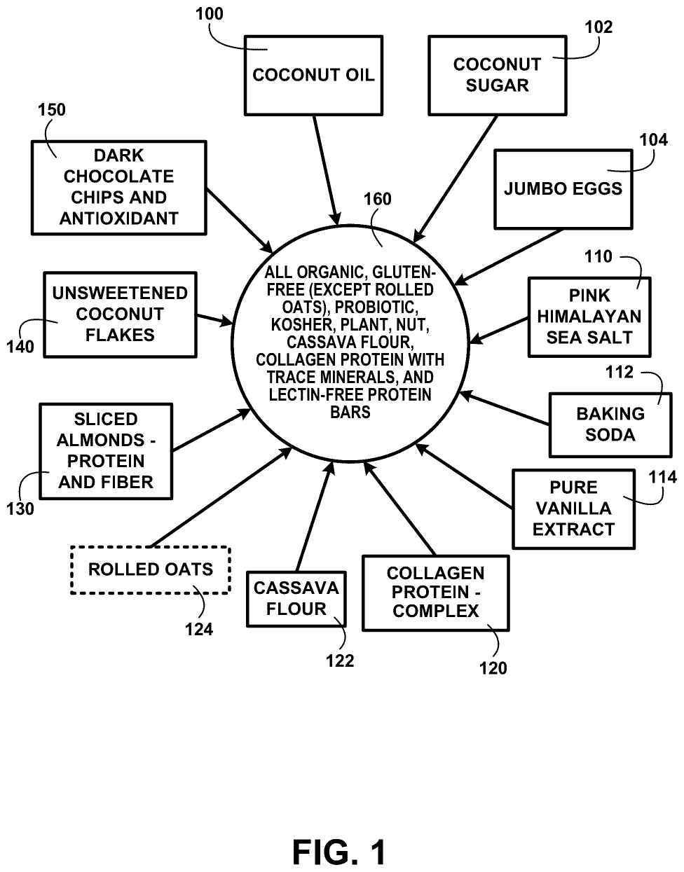

FIG. 1 shows for illustrative purposes only an example of a collagen protein bar ingredients of one embodiment. FIG. 1 shows ingredients mixed, blended, and stirred in a mixture of collagen protein bars processed into protein bar shapes for human consumption. The first group of ingredients includes coconut oil 100, coconut sugar 102, and jumbo eggs 104 in a first mixture. A second group of ingredients are blended into the first mixture and includes pink Himalayan sea salt 110, baking soda 112, and pure vanilla extracts 114 in a second mixture. A third optional group of ingredients includes, in one embodiment, a third group of collagen protein-complex 120 and cassava flour 122 stirred into the second mixture to prepare a third mixture. In another embodiment, a third group of collagen protein-complex 120, cassava flour 122, and rolled oats 124 stirred into the second mixture to prepare a third mixture. A fourth group of ingredients includes sliced almonds-protein and fiber 130 that are stirred into the third mixture to prepare a fourth mixture. A fifth group of ingredients includes unsweetened coconut flakes 140 that are stirred into the fourth mixture to prepare a fifth mixture. After pressing the fifth mixture into baking sheets, a sixth group of ingredients including dark chocolate chips and antioxidant 150 is placed on top of the prepared mixture of cassava flour and collagen protein mixture before baking. The collagen protein bars are all organic, gluten-free (except rolled oats), probiotic, kosher, plant, nut, cassava flour, collagen protein with trace minerals, and lectin-free protein bars 160. The bars with oats are Lectin reduced and not gluten-free of one embodiment.

### DETAILED DESCRIPTION

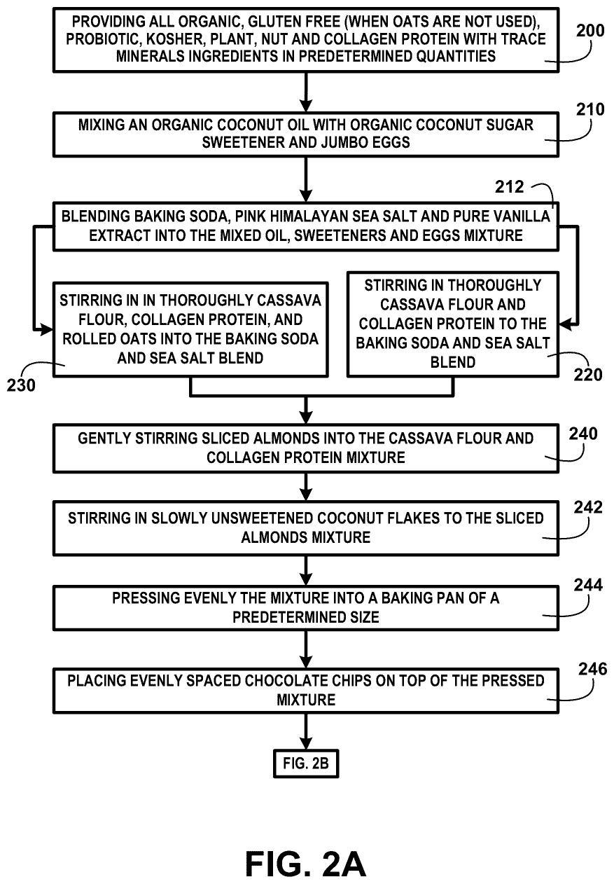

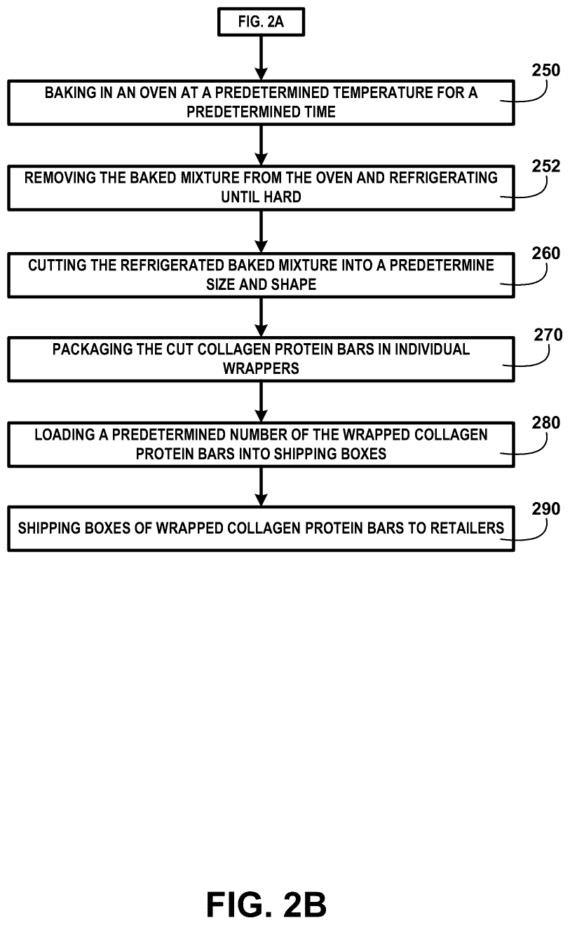

FIG. 2A shows a block diagram of an overview flow chart of preparing collagen protein bar ingredients of one embodiment. FIG. 2A shows providing all organic, gluten-free (when oats are not used), probiotic, kosher, plant, nut, and collagen protein with trace minerals ingredients in predetermined quantities 200. The ingredients are prepared by mixing organic coconut oil with organic coconut sugar sweetener and jumbo eggs 210 in a mixture. The preparations include blending baking soda, pink Himalayan sea salt, and pure vanilla extract into the mixed oil, sweeteners, and egg mixture 212. The preparations further include stirring in thoroughly cassava flour and collagen protein in the baking soda and sea salt blend 220. Stirring in thoroughly cassava flour, collagen protein, and rolled oats into the baking soda and sea salt blend 230 is one embodiment of these ingredients. Stirring in thoroughly cassava flour, collagen protein, and no rolled oats into the baking soda and sea salt blend is another embodiment that is gluten-free. The mixture is also fortified by gently stirring sliced almonds into the cassava flour and collagen protein mixture 240. The previous mixtures also are further prepared by stirring in slowly unsweetened coconut flakes to the sliced almonds mixture 242. The combined mixtures are prepared for baking by pressing evenly the mixture into a baking pan of a predetermined size 244. The pressed mixture includes placing evenly spaced chocolate chips on top of the pressed mixture 246 of one embodiment. The pre-baking mixture is further described in FIG. 2B.

### Manufacturing Processes for Baking in an Oven:

FIG. 2B shows a block diagram of an overview flow chart of manufacturing processes for baking in an oven collagen protein bars of one embodiment. FIG. 2B shows a continuation from FIG. 2A. The pressed mixture with chocolate chip toppings is baking in an oven at a predetermined temperature for a predetermined time 250. The preparation continues by removing the baked mixture from the oven and refrigerating until hard 252. The hardened mixture is more effectively cut into individual protein bars. The baking sheets are moved along the conveyor belt for cutting the refrigerated baked mixture into a predetermined size and shape 260. The cut individual protein bars are conveyed for packaging the cut collagen protein bars in individual wrappers 270. The individual wrappers protect and add to the shelf life of the collagen protein bars. The preparation for shipping includes loading a predetermined number of the wrapped collagen protein bars into shipping boxes 280. The shipping boxes of wrapped collagen protein bars to retailers 290 include pre-labeling the boxes and staking the shipping boxes on palettes to load into trucks of one embodiment.

### Manufacturing Devices for a Plurality of Holding Tanks:

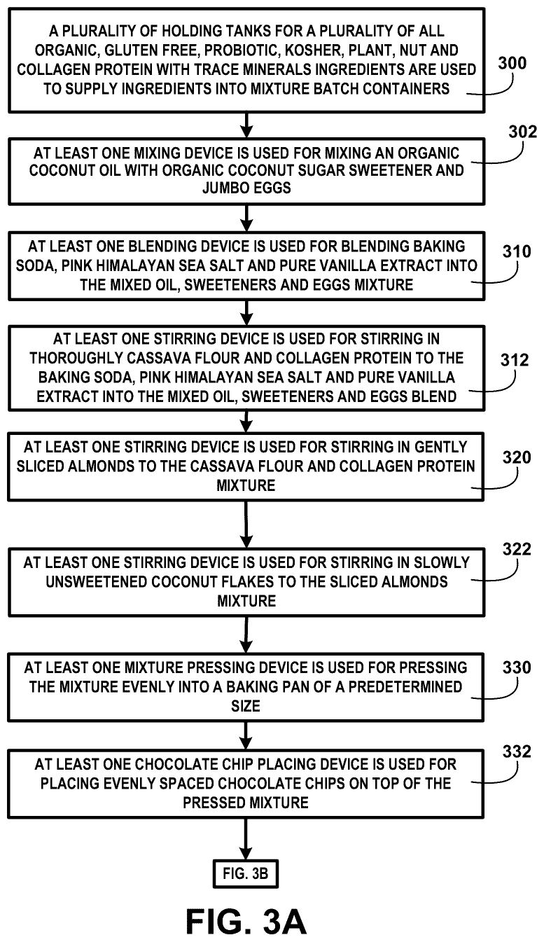

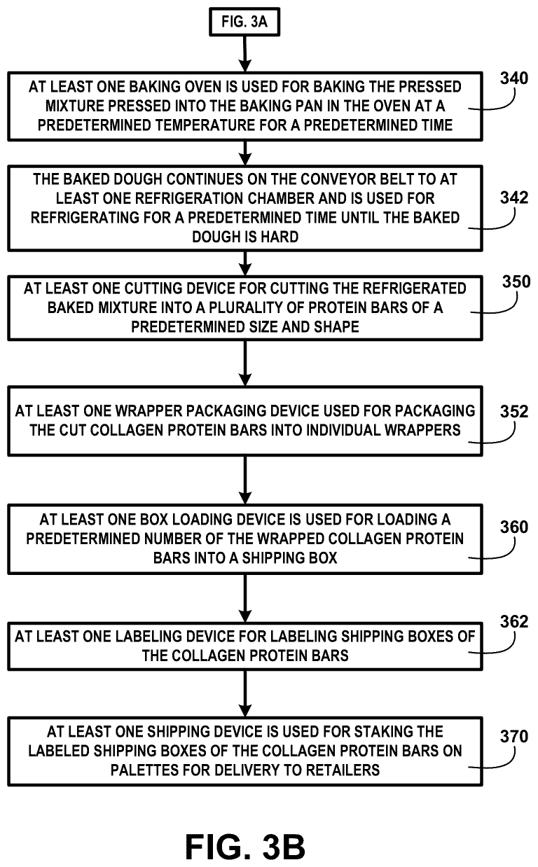

FIG. 3A shows a block diagram of an overview flow chart of the manufacturing process for a plurality of holding tanks of one embodiment. FIG. 3A shows a plurality of holding tanks for a plurality of all organic, gluten-free (when oats are not used), probiotic, kosher, plant, nut, and collagen protein with trace minerals ingredients are used to supply ingredients into mixture batch containers 300. The collagen protein bars holding tanks supply at least one mixing device. At least one mixing device is used for mixing organic coconut oil with organic coconut sugar sweetener and jumbo eggs 302 ingredients in a batch container. At least one blending device is used for blending baking soda, pink Himalayan sea salt, and pure vanilla extract into the mixed oil, sweeteners, and egg mixture 310 batch container. At least one stirring device is used for stirring in thoroughly cassava flour and collagen protein in the baking soda and sea salt blend 312 in the batch container continues the mixture recipe. At least one stirring device is used for stirring in gently sliced almonds to the cassava flour and collagen protein mixture 320, adding this ingredient to the mixture batch container. At least one stirring device is used for stirring in slowly unsweetened coconut flakes to the sliced almonds mixture 322 and forms the collagen protein bar dough. The collagen protein bar dough is placed in a predetermined quantity onto a baking pan or sheet. At least one mixture pressing device is used for pressing the mixture evenly into a baking pan of a predetermined size 330. At least one chocolate chip placing device is used for placing evenly spaced chocolate chips on top of the pressed mixture 332 of one embodiment. The manufacturing process is further described in FIG. 3B.

### Manufacturing Process for Baking the Pressed Mixture:

FIG. 3B shows a block diagram of an overview flow chart of a continuation of the manufacturing process for baking the pressed mixture of one embodiment. FIG. 3B shows a continuation from FIG. 3A. At least one baking oven is used for baking the pressed mixture pressed into the baking pan in the oven at a predetermined temperature for a predetermined time 340. The baked dough continues on the conveyor belt to at least one refrigeration chamber and is used for refrigerating for a predetermined time until the baked dough is hard 342. Once hard the baked dough is conveyed to at least one cutting device for cutting the refrigerated baked mixture into a plurality of protein bars of a predetermined size and shape 350. The individually cut protein bars are fed through an alignment device integrated into the conveyor belt. The aligned individual cut protein bars then pass to at least one wrapper packaging device used for packaging the cut collagen protein bars into individual wrappers 352. The wrapper protects the collagen protein bar and extends the shelf life of the collagen protein bar. At least one box loading device is used for loading a predetermined number of the wrapped collagen protein bars into a shipping box 360. At least one labeling device is used for labeling shipping boxes of the collagen protein bars 362. Once filled and labeled, at least one shipping device is used for staking the labeled shipping boxes of the collagen protein bars on palettes for delivery to retailers 370 of one embodiment.

### Manufacturing Devices for a Mixing Process:

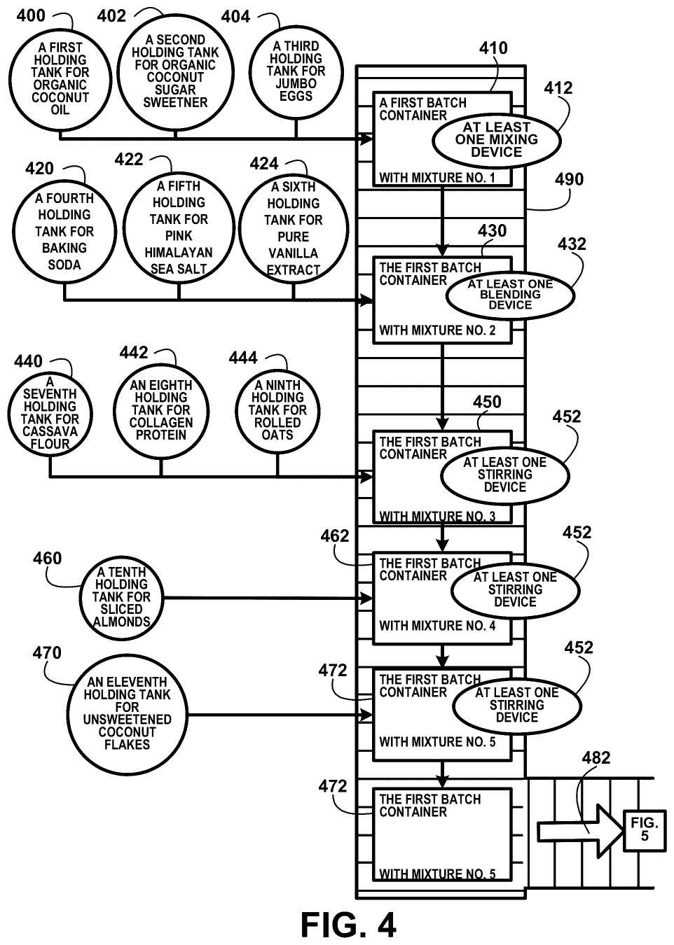

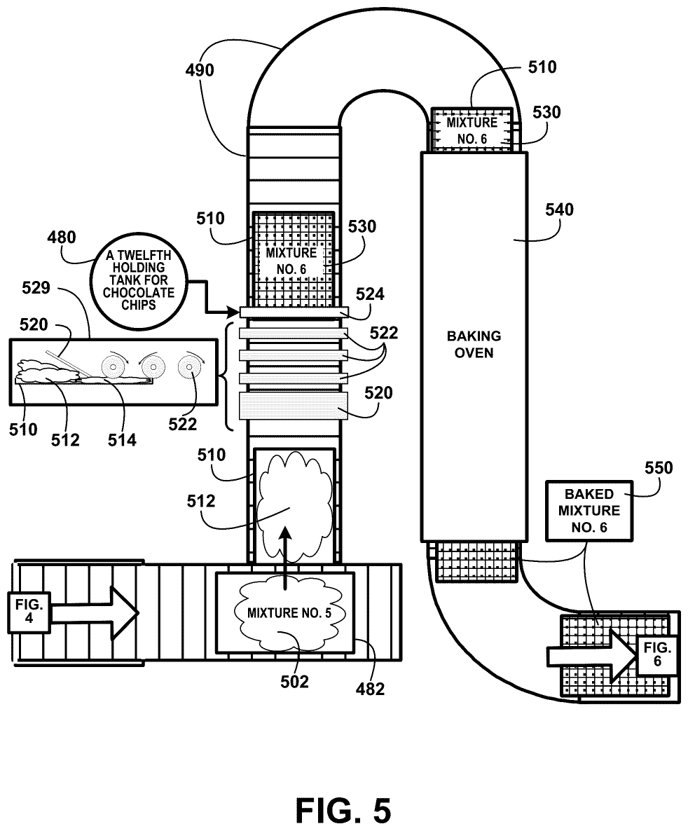

FIG. 4 shows for illustrative purposes only an example of a manufacturing mixing process of collagen protein bars of one embodiment. FIG. 4 shows a first holding tank for organic coconut oil 400, a second holding tank for organic coconut sugar sweetener 402, and a third holding tank for jumbo eggs 404. The first, second, and third holding tanks deposit a predetermined quantity of each ingredient into a first batch container with mixture no. 1 410 for combining and mixing those ingredients. At least one mixing device 412 is used for mixing the first batch of container ingredients. The first batch container is moved on a conveyor belt 490 to a second position. A fourth holding tank for baking soda 420, a fifth holding tank for pink Himalayan sea salt 422, and a sixth holding tank for pure vanilla extract 424 deposit a predetermined quantity of these ingredients into the first batch container with mixture no. 2 430. At least one blending device 432 for blending the added ingredients with the previously mixed ingredients. The at least one blending device 432 is used for blending the baking soda, pink Himalayan sea salt, and pure vanilla extract into the mixed oil, sweeteners, and egg mixture. In one embodiment, a seventh holding tank for cassava flour 440, and an eighth holding tank for collagen protein 442 for depositing a predetermined quantity of these ingredients into the first batch container with mixture no. 3 450 for stirring the previously mixed ingredients with at least one stirring device 452 for the cassava flour and collagen protein. In another embodiment, a ninth holding tank for rolled oats 444 deposits a predetermined quantity of the rolled oats together with the cassava flour and collagen protein ingredients. These three ingredients deposited into the first batch container with mixture no. 3 450 are processed by stirring the previously mixed ingredients with at least the newly added cassava flour, collagen protein, and rolled oats 450 using at least one stirring device 452. A tenth holding tank for sliced almonds 460 deposits a predetermined quantity of the sliced almonds into the first batch container with mixture no. 4 462 for stirring the previously mixed ingredients with the sliced almonds using at least one stirring device 452. An eleventh holding tank for unsweetened coconut flakes 470 deposits a predetermined quantity of the unsweetened coconut flakes into the first batch container with mixture no. 5 472 for stirring the previously mixed ingredients with the unsweetened coconut flakes using at least one stirring device 452. The first batch container with mixture no. 5 472 containing all the mixed, blended, and stirred ingredients continues being conveyed for baking 482 of one embodiment. The process descriptions continue in FIG. 5.

### Manufacturing Devices for a Baking Process:

FIG. 5 shows for illustrative purposes only an example of a manufacturing baking process of collagen protein bars of one embodiment. FIG. 5 shows a continuation from FIG. 4. FIG. 5 shows the mixture of the ingredients mixture no. 5 502. In the first batch container containing the previously mixed ingredients being conveyed for baking 482. A predetermined quantity of the ingredient's mixture no. 5 is placed on a baking sheet 512. A baking sheet 510 holds the ingredients mixture no. 5 while an angled leveling device is used to level the mixture of the fresh ingredients in the baking sheet 520. A plurality of rollers is used to press the ingredients mixture onto the baking sheet 522. FIG. 5 shows a profile view of a mixture pressing system 529 showing the baking sheet 510 with a portion of the ingredients mixture placed on a baking sheet 512. The angled leveling device levels the fresh ingredients mixture in the baking sheet 520.

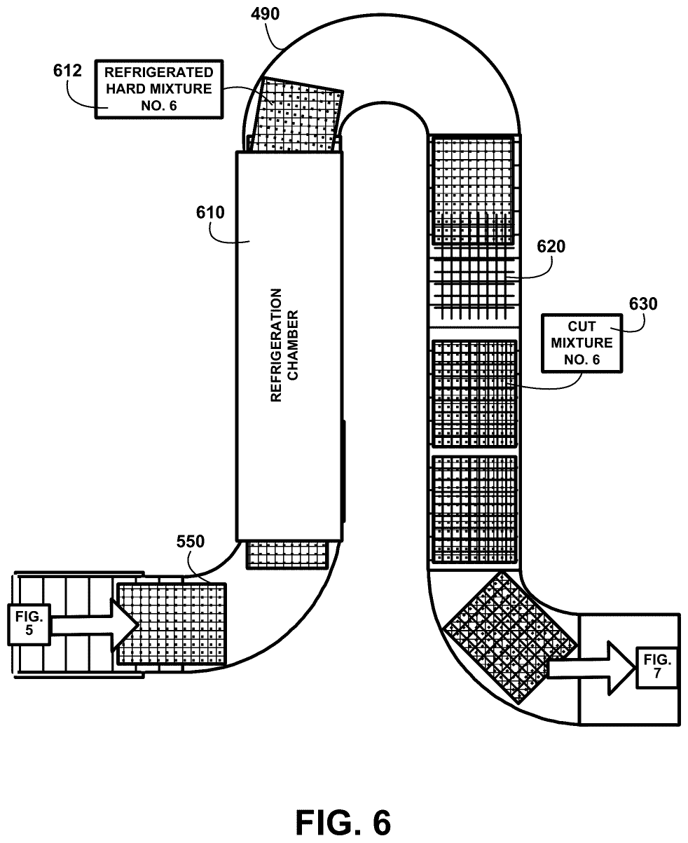

The plurality of rollers presses the ingredients mixture onto the baking sheet 522 to produce pressed ingredients mixture 514 on the baking sheet 510. A twelfth holding tank for chocolate chips 480 supplies a predetermined number of chocolate chips into at least one chocolate chip placing device for placing evenly spaced chocolate chips on top of the pressed mixture 524. The pressed ingredients mixture with evenly placed chocolate chips 530 on the baking sheet 510 travels on the conveyor belt 490 to at least one baking oven 540. The pressed ingredients mixture with evenly placed chocolate chips 530 on the baking sheet travels through the baking oven for a predetermined time. The baked pressed ingredients mixture with evenly placed chocolate chips in the baking sheet 550 then continues on the conveyor belt 490 of one embodiment. The protein bar production descriptions continue in FIG. 6.

### Manufacturing Devices for Refrigeration and Cutting Process:

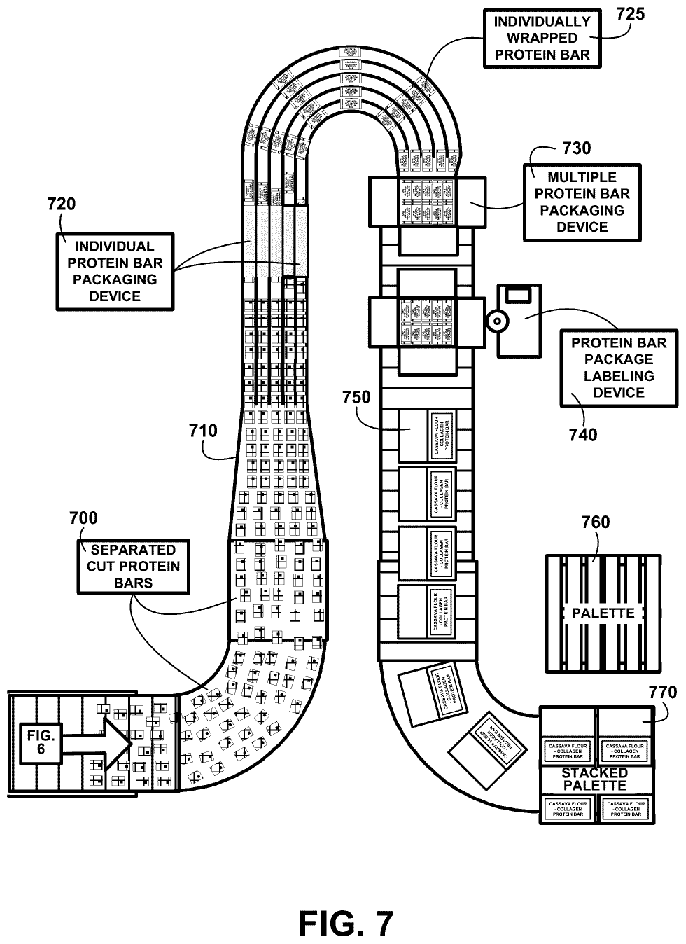

FIG. 6 shows for illustrative purposes only an example of the refrigeration and cutting process of collagen protein bars of one embodiment. FIG. 6 shows a continuation from FIG. 5 where the baked pressed ingredients mixture with evenly placed chocolate chips in the baking sheet 550 are conveyed to at least one refrigeration chamber 610. The baked pressed ingredients mixture with evenly placed chocolate chips in the baking sheet 550 travel through at least one refrigeration chamber 610 for a predetermined time on the conveyor belt until the baked pressed ingredients mixture is hard. The conveyor belt 490 moves the baking sheet of the hard-baked mixture 612 to at least one cutting device 620. At least one cutting device applies a plurality of cutting blades force against the refrigerated pressed ingredients mixture with evenly placed chocolate chips to cut the hard mixture into a plurality of predetermined sized and shaped 630 individual protein bars of one embodiment. The processing is further described in FIG. 7.

### Manufacturing Devices for a Packaging Process:

FIG. 7 shows for illustrative purposes only an example of a manufacturing packaging process of collagen protein bars of one embodiment. FIG. 7 shows a continuation from FIG. 6 where separated individual cut protein bars 700 are passed through alignment guides to channel the individual cut protein bars to a wrapper packaging device 710. At least one individual protein bar packaging device 720 encloses each individually wrapped protein bar 725 in a wrapper to protect the protein bar against contamination and extend the shelf life. A predetermined number of the wrapped protein bars are conveyed into at least one multiple protein bar packaging device 730 box loading device. At least one box loading device places the predetermined number of the wrapped protein bars into a shipping box. The shipping box is closed, sealed, and then labeled using at least one protein bar package labeling device 740. The labeled box of the collagen protein bars 750 are conveyed to a shipping palette stacking device 760 and the labeled boxes of the collagen protein bars are stacked on a palette for shipping 770 of one embodiment.

### Cassava Flour:

The collagen protein bars ingredients include cassava flour. Cassava flour is gluten-free flour made from the tuber cassava, which is native to South America and grown in tropical and subtropical regions. Cassava flour has a mineral content similar to wheat flour. Cassava flour has a light or neutral nutty flavor taste and a fine or smooth texture. Cassava flour has low moisture content giving cassava flour a long dry shelf life. Cassava flour is a highly versatile ingredient with numerous uses in the food industry, including in all sorts of baked goods, tortillas, porridge, pancakes, and gluten-free pasta and pizza, and as a thickener for ice cream, sauces, and dressings 850 of one embodiment

Studies have shown the benefits of consuming cassava flour products that come from their high resistant starch content. Resistant starch may improve metabolic markers, such as blood sugar and cholesterol levels, which are linked to non-communicable diseases (NCDs) and may help lower blood cholesterol levels. Resistant starch in cassava flour may aid weight loss by regulating your appetite and reducing fat mass. When bacteria in the gut digest resistant starch, they produce short-chain fatty acids (SCFAs). The SCFAs trigger the release of the hunger-reducing hormones peptide yy (PYY) and glucagon-like peptide 1 (GLP-1). The SCFAs are credited with improving insulin sensitivity, meaning that human cells respond better to the hormone insulin. The SCFAs are credited with slowing down the rate of digestion of foods, leading to a slower rise in blood glucose levels of one embodiment.

Studies have shown cassava flour nutrition is beneficial to a healthy diet. A ¼ cup (35 grams) serving of cassava flour provides the following nutritional portions including calories: 130, protein: 0 grams, fat: 0 grams, carbs: 31 grams, fiber: 2 grams, potassium: 2% of the daily value (DV), and calcium: 1.5% of the DV. Cassava flour is a carb-rich food with virtually no fat or protein of one embodiment.

### Collagen Protein:

The collagen protein bars ingredients include collagen protein 1100. Studies have shown collagen is 30% of a human's body protein. Collagen provides structure, support, or strength to your skin, muscles, bones, connective tissues, organs, blood vessels, and intestinal lining. A well-balanced diet gives your body the raw ingredients it needs to help it make collagen naturally. A well-balanced diet includes vegetables, beans, whole grains, nuts, and fruits and a moderate amount of seafood, meats, poultry, dairy, and eggs.

The benefits of consuming collagen protein products are maintaining the body's collagen level. The collagen in a human helps fibroblasts to form in your dermis (middle skin layer), which helps new cells grow. Collagen helps in replacing dead skin cells, providing a protective covering for organs, giving structure, strength, and elasticity to your skin, and helping your blood to clot of one embodiment.

Studies have shown the human body produces less collagen with aging. It is normal for everyone to experience a decline in collagen production after age 60. The collagen is also lower in quality than when younger. Women experience a significant reduction in collagen production after menopause. Autoimmune diseases can damage collagen and therein lower the normal body's collagen levels of one embodiment.

Studies show collagen protein nutrition information shows fourteen grams of collagen peptide (supplement) contains: the following nutritional values including calories: 50, protein: 12 grams, fat: 0 grams, carbohydrates: 0 grams, fiber: 0 grams, and sugar: 0 grams one embodiment.

### Lectin Free Information:

The collagen protein bars are lectin-free protein bars. Studies have shown lectins are found in all plants, but raw legumes (beans, lentils, peas, soybeans, peanuts) and whole grains like wheat contain the highest amounts of lectins. Lectins, or hemagglutinins, are an “anti-nutrient”. Studies have shown lectins as a major cause of obesity, chronic inflammation, and autoimmune diseases. Lectins are defined as proteins that bind to carbohydrates. The same features that lectins use to defend plants in nature may cause problems during human digestion. They resist being broken down in the gut and are stable in acidic environments, features that protect lectin-containing plants in nature. Lectins when consumed in their active state can cause negative side effects of one embodiment.

Lectins contain phytohaemagglutinin, a type of lectin that can cause red blood cells to clump together. Phytohaemagglutinin, a type of lectin can also produce nausea, vomiting, upset stomach, and diarrhea and milder side effects include bloating and gas. Active lectins can interfere with the absorption of minerals, especially calcium, iron, phosphorus, and zinc. Legumes and cereals often contain these minerals, so the concurrent presence of lectins may prevent the absorption and use of these minerals in the body. Lectins can also bind to cells lining the digestive tract and may disrupt the breakdown and absorption of nutrients and affect the growth and action of intestinal flora. Because lectin proteins bind to cells for long periods, they can potentially cause an autoimmune response and are theorized to play a role in inflammatory conditions like rheumatoid arthritis and type 1 diabetes. While it is true that certain lectins are toxic and cause harm when consumed in excess, they are easy to get rid of by cooking the legumes and cereals; for example, boiling legumes in water eliminates almost all lectin activity of one embodiment.

### Collagen Protein Bar Ingredients by Weight:

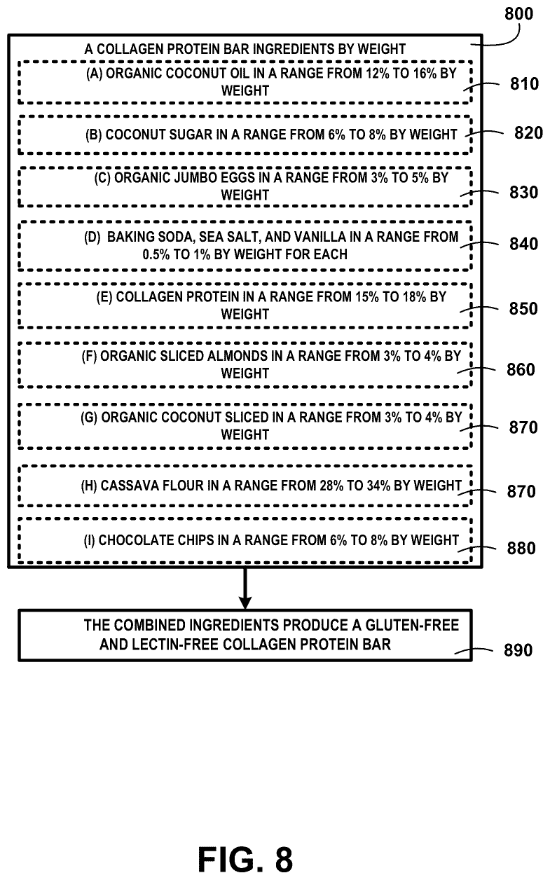

FIG. 8 shows a block diagram of an overview of collagen protein bar ingredients by weight of one embodiment. FIG. 8 shows collagen protein bar ingredients by weight 800. The ingredients in part are selections made within a component group. The ingredients include (a) in a range from 12% to 16% of organic coconut oil 810 that is non-GMO, (b) in a range from 6% to 8% of coconut sugar 820, and (c) in a range from 3% to 5% of organic jumbo eggs 830.

The organic jumbo eggs may alternatively be an equivalent volume of regular-sized eggs. In one embodiment the egg component may be eggs from fowl other than chickens, for example, turkey, game birds, or ostrich eggs.

In one embodiment the ingredients include (d) in a range from 0.5% to 1% by weight each of baking soda, sea salt, and vanilla 840. Vanilla is one of the group of spice extract components. The ingredients include (e) in a range from 15% to 20% by weight of collagen protein 850 and (f) in a range from 3% to 4% by weight of organic sliced almonds 860.

The sliced almonds are selected from a group of at least one organic nut from a group of at least almonds, Brazil, cashew, macadamias, and pistachios other organic nuts. The ingredients include for example (g) in a range from 3% to 4% by weight of organic coconut sliced 870. Sliced coconut is a preferred ingredient over shredded coconut. The ingredients include (h) in a range from 28% to 34% by weight of cassava flour 870. Cassava flour is rich in carbohydrates and vitamin C, is gluten-free, and low in calories, fat, and sugar. The ingredients include (i) in a range from 6% to 8% by weight of chocolate chips 880.

The chocolate chips include a selection of chocolates from a group of at least milk, dark and white chocolates. The finished collagen protein bar is at least one and one-half inches wide and at least two and one-quarter inches long. The combined ingredients produce a gluten-free and lectin-free collagen protein bar 890 of one embodiment.

### Collagen Protein Bar Taste Components:

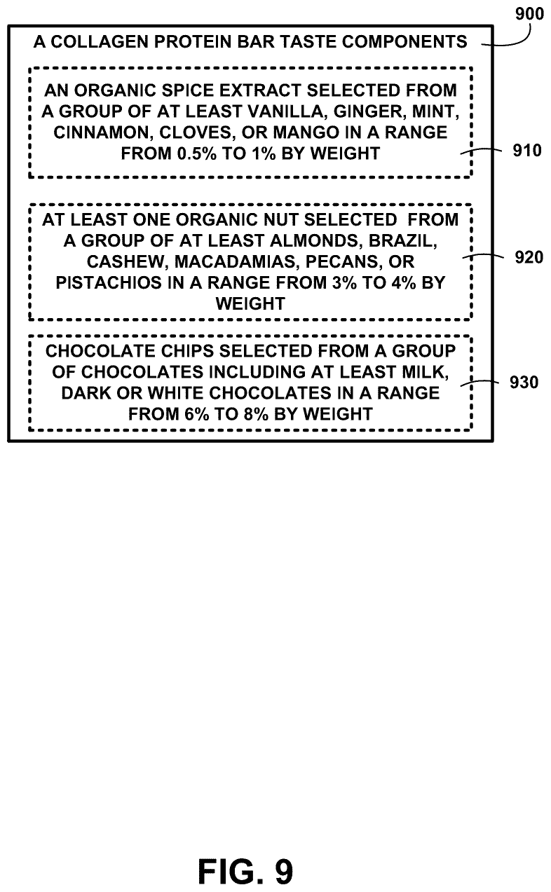

FIG. 9 shows a block diagram of an overview of a collagen protein bar taste components of one embodiment. FIG. 9 shows a collagen protein bar taste components 900. The collagen protein bar taste components 900 are combined and mixed with the component and then processed to create the collagen protein bar. In one embodiment taste components in a range from 0.5% to 1% by weight of an organic spice extract selected from a group of at least vanilla, ginger, mint, cinnamon, cloves, or mango 910. Spice extracts include antibacterial, antifungal, and antiviral properties.

In another embodiment, taste components in a range from 3% to 4% by weight include at least one organic nut selected from a group of at least almonds, Brazil, cashew, macadamias, pecans, or pistachios 920. Studies have shown that nuts are high in fiber, protein, healthy fats, and a variety of vitamins and minerals.

In yet another embodiment taste components in a range from 6% to 8% by weight of chocolate chips are selected from a group of chocolates including at least milk, dark or white chocolates 930. Studies have shown dark chocolate has at least 50% cocoa that is rich in flavanols. Cocoa flavanols have antioxidant, anti-inflammatory, and free-radical properties. Dark chocolate is a rich source of fiber and has high contents of iron, magnesium, zinc, copper, and other minerals.

### Collagen Protein Bar Chewiness:

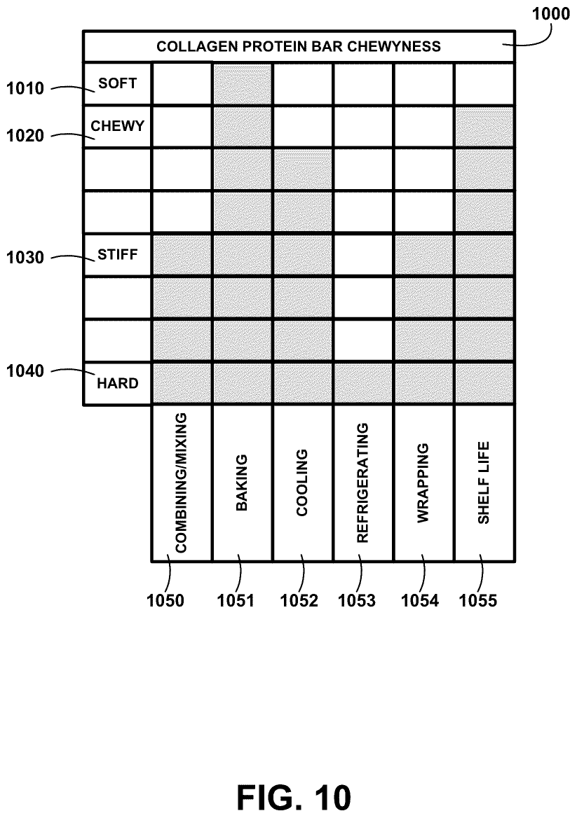

FIG. 10 shows a block diagram of an overview of collagen protein bar chewiness of one embodiment. FIG. 10 shows in one embodiment a chart of a collagen protein bar chewiness 1000 during manufacturing processes. Chewiness is ranked from soft 1010, chewy 1020, stiff 1030, to hard 1040. The manufacturing processes include in one example combining/mixing 1050 the ingredients, baking 1051, cooling 1052 after baking, refrigerating 1053, wrapping 1054 the formed collagen protein bars, and shelf life 1055. In the combining/mixing 1050 process, the mixture is stiff 1030. During baking 1051 the mixture becomes soft 1010. A short cooling 1052 period after baking 1051 brings the mixture to just below chewy 1020. A process of refrigerating 1053 makes the baked collagen protein bar mixture to a hard 1040 firmness for cutting. The individually cut collagen protein bars during wrapping 1054 are stiff 1030. After wrapping and a packaging and shipping process during a shelf life 1055 the collagen protein bars are chewy 1020. In another embodiment cellulose and xanthan gums may be added to the mixture ingredients to stabilize chewiness during the shelf life. The cellulose and xanthan gums are binding and thickening agents that add to the chewy texture of one embodiment.

### A Process for Manufacturing a Collagen Protein Bar:

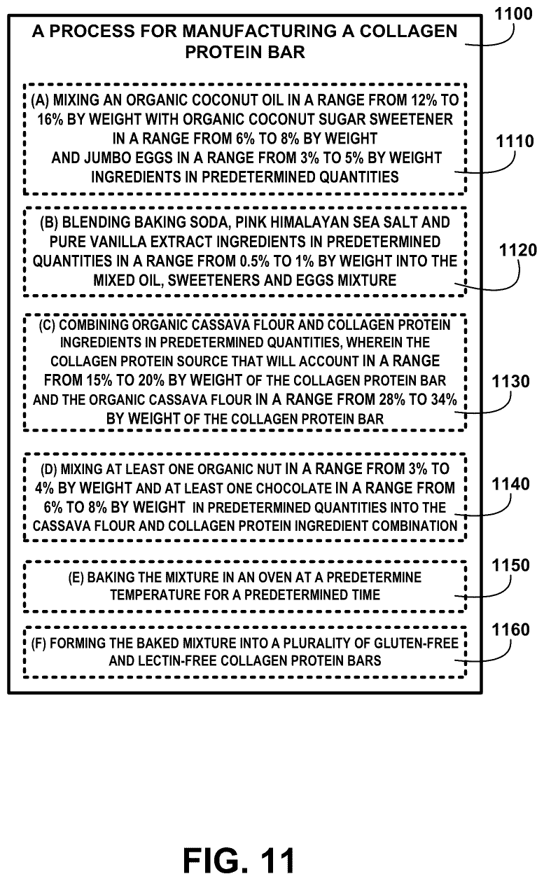

FIG. 11 shows a block diagram of an overview of a process for manufacturing a collagen protein bar of one embodiment. FIG. 11 shows a process for manufacturing a collagen protein bar 1100. A process for manufacturing a collagen protein bar 1100 includes (a) mixing an organic coconut oil in a range from 12% to 16% by weight with organic coconut sugar sweetener in a range from 6% to 8% by weight and jumbo eggs in a range from 3% to 5% by weight ingredients in predetermined quantities 1110

The process continues with (b) blending baking soda, pink Himalayan sea salt and pure vanilla extract ingredients in predetermined quantities in a range from 0.5% to 1% by weight into the mixed oil, sweeteners and eggs mixture 1120. The ingredient blending continues with (c) combining organic cassava flour and collagen protein ingredients in predetermined quantities, wherein the collagen protein source that will account in a range from 15% to 20% by weight of the collagen protein bar and the organic cassava flour in a range from 28% to 34% by weight of the collagen protein bar 1130. Further ingredient mixture preparation includes (d) mixing at least one organic nut in a range from 3% to 4% by weight and at least one chocolate in a range from 6% to 8% by weight in predetermined quantities into the cassava flour and collagen protein ingredient combination 1140. The mixture is evenly pressed into a baking pan of a predetermined size. The baking pan with the evenly pressed mixture is processed for (e) baking the mixture in an oven at a predetermine temperature for a predetermined time 1150. The processing continues with (f) forming the baked mixture into a plurality of gluten-free and lectin-free collagen protein bars 1160. Forming includes refrigerating the baked mixture for a predetermined time until hard in preparation for cutting the refrigerated baked mixture into a predetermined size and shape. The process continues with packaging the cut collagen protein bars in individual wrappers. The individually wrapped gluten-free and lectin-free collagen protein bars are boxed and shipped to retailers of one embodiment.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed is:

1. A process for manufacturing a collagen protein bar, comprising:
(a) mixing an organic coconut oil in a range from 12% to 16% by weight with organic coconut sugar sweetener in a range from 6% to 8% by weight and jumbo eggs in a range from 3% to 5% by weight ingredients in predetermined quantities;
(b) blending baking soda, pink Himalayan sea salt and pure vanilla extract ingredients in predetermined quantities in a range from 0.5% to 1% by weight into the mixed oil, sweeteners and eggs mixture;
(c) combining organic cassava flour and collagen protein ingredients in predetermined quantities, wherein the collagen protein source that will account in a range from 15% to 20% by weight of the collagen protein bar and the organic cassava flour in a range from 28% to 34% by weight of the collagen protein bar;
(d) mixing at least one organic nut in a range from 3% to 4% by weight and at least one chocolate in a range from 6% to 8% by weight in predetermined quantities into the cassava flour and collagen protein ingredient combination;
(e) baking the mixture in an oven at a predetermine temperature for a predetermined time; and
(f) forming the baked mixture into a plurality of collagen protein bars.

2. The process of claim 1, wherein ingredients include organic non-GMO coconut oil in a range from 12% to 16% by weight and coconut sugar in a range from 6% to 8% by weight of the total weight of the collagen protein bar.

3. The process of claim 1, wherein ingredients include jumbo eggs in a range from 3% to 5% by weight of the total weight of the collagen protein bar.

4. The process of claim 1, wherein ingredients include baking soda by weight and sea salt in a range from 0.5% to 1% by weight of the total weight of the collagen protein bar.

5. The process of claim 1, wherein ingredients include vanilla in a range from 0.5% to 1% by weight of the total weight of the collagen protein bar.

6. The process of claim 1, further comprising refrigerating the baked mixture for a predetermined time until hard.

7. The process of claim 1, wherein combining and mixing the ingredients produces a gluten-free and lectin-free collagen protein bar.

8. A collagen protein bar, comprising:
(a) organic coconut oil in a range from 12% to 16% by weight;
(b) coconut sugar in a range from 6% to 8% by weight;
(c) organic jumbo eggs in a range from 3% to 5% by weight;
(d) baking soda, sea salt, and a spice extract in a range from 0.5% to 1% by weight;
(e) collagen protein in a range from 15% to 20% by weight;
(f) organic nuts in a range from 3% to 4% by weight;
(g) organic coconut sliced in a range from 3% to 4% by weight;
(h) cassava flour in a range from 28% to 34% by weight;
(i) chocolate chips in a range from 6% to 8% by weight wherein the ingredients; and
produce a gluten-free and lectin-free collagen protein bar.

9. The collagen protein bar of claim 8, wherein a combination of the ingredients produces a gluten-free and lectin-free collagen protein bar.

10. The collagen protein bar of claim 8, wherein the collagen protein bar is at least one and one-half inches wide and at least two and one-quarter inches long.

11. The collagen protein bar of claim 8, wherein the organic coconut oil is non-GMO.

12. The collagen protein bar of claim 8, wherein cassava flour is rich in carbohydrates and vitamin C, is gluten-free, lectin-free, and low in calories, fat, and sugar.

13. The collagen protein bar of claim 8, wherein the chocolate chips include a selection of chocolates from a group of at least milk, dark and white chocolates.

14. The collagen protein bar of claim 8, wherein the sliced almonds are selected from a group of at least one organic nut from a group of at least Brazil, cashew, macadamias, and pistachios other organic nuts.

15. A collagen protein bar comprising:
(a) organic coconut oil in a range from 12% to 16% by weight;
(b) coconut sugar in a range from 6% to 8% by weight;
(c) organic jumbo eggs in a range from 3% to 5% by weight;
(d) baking soda, sea salt, and a spice extract in a range from 0.5% to 1% by weight;
(e) collagen protein in a range from 15% to 20% by weight;
(f) organic nuts in a range from 3% to 4% by weight;
(g) organic coconut sliced in a range from 3% to 4% by weight;
(h) cassava flour in a range from 28% to 34% by weight;
(i) chocolate chips in a range from 6% to 8% by weight wherein the ingredients; and
produce a gluten-free and lectin-free collagen protein bar.

16. The collagen protein bar of claim 15, wherein an organic spice extract is selected from a group of at least vanilla, ginger, mint, cinnamon, cloves, and mango.

17. The collagen protein bar of claim 15, wherein the organic coconut oil is non-GMO.

18. The collagen protein bar of claim 15, wherein the chocolate chips include a selection of chocolates from a group of at least milk, dark and white chocolates.

19. The collagen protein bar of claim 15, cassava flour is rich in carbohydrates and vitamin C, is gluten-free, and low in calories, fat, and sugar.

20. The collagen protein bar of claim 15, wherein an ingredient may include rolled oats.
